(19) United States
(12) Patent Application Publication
(10) Pub. No.: US 2012/0141734 A1
(43) Pub. Date: Jun. 7, 2012

(54) MATTE-SURFACE SUBSTRATE AND MANUFACTURING METHOD THEREOF

(76) Inventor: Chun-Yuan Lee, Hsinchu (TW)

(21) Appl. No.: 13/309,698

(22) Filed: Dec. 2, 2011

(30) Foreign Application Priority Data
Dec. 3, 2010 (TW) 99142165

(51) Int. Cl. B32B 3/30; B05D 3/10; B05D 3/02; B05D 3/12; B05D 3/06

(52) U.S. Cl. 428/141; 427/273; 427/510

(57) ABSTRACT

A method for manufacturing matte-surface substrate including the following steps: coating a layer of material layer on a substrate; forming a plurality of liquid dewdrops on a surface of the coated material layer; applying an action caused by difference of surface tension between the liquid dewdrops and the coated material layer or by difference of concentration between the coated material layer and the liquid dewdrops to cause shape variation of the surface of the coated material layer so as to form a plurality of irregular raised/recessed structures; and finally curing the coated material layer and removing the liquid dewdrops. As such, a matte-surface substrate that includes successively-arranged irregular raised/recessed structures formed on the surface of the coated material layer is provided.

### BACKGROUND OF THE INVENTION

1. Field of the Invention

The present invention relates to a substrate and a manufacturing method thereof, and in particular to a matte-surface substrate and a manufacturing method thereof.

2. The Related Arts

Conventionally, various ways are adopted to make a matte-surface substrate. FIGS. 1-3 demonstrate a first example of making a conventional matte-surface substrate. The first example adopts an etching process, in which a substrate A10 is first coated, on a top thereof, with a porous particle material A20, as shown in FIG. 1. Then, as illustrated in FIG. 2, the substrate A10 with the porous particle material A20 coated thereon is dipped into a chemical agent (not shown) to be subjected to etching. Due to the coating on the surface of the substrate A10 being a porous particle material A20, porous are present to allow the chemical agent to permeate through the porous particle material A20 and contact the substrate A10 and thus etching the surface of the substrate A1 and forming numerous irregular raised/recessed structures A12 on the surface of the substrate A10. Finally, the porous particle material A20 is removed and a matte-surface substrate A1 is completed, as shown in FIG. 3. The matting effect is provided by the irregular raised/recessed structures A12 on the surface of the substrate A10.

FIGS. 4-6 demonstrate a second example of making a known matte-surface substrate. The second example also adopts an etching process with the difference being that the top of the substrate A10 is coated with a shielding material A30. The shielding material A30 is not coated in a uniform and complete manner and is actually applied in an arrayed fashion, as illustrated in FIG. 4. Then, as shown in FIG. 5, the substrate A10 with the shielding material A30 coated thereon is dipped into a chemical agent (not shown) to be subjected to etching. Since the shielding material A30 applied to the surface of the substrate A10 can block the chemical agent from contacting the surface of the substrate A10, the portions of the substrate A10 that are covered by the shielding material A30 are not etched, but the portions of the substrate A10 that are not covered by the shielding material A30 are etched. In this way, after the etching operation, numerous irregular raised/recessed structures A12 are formed on the surface of the substrate A10, as shown in FIG. 6, and a matte-surface substrate A1 is completed.

However, the etching processes adopted conventionally use chemical agents that may cause pollution to the environments and environmental protection issues may be raised. Other methods for manufacturing matte-surface substrate are thus proposed, such as sandblasting. The sandblasting process is carried out by jetting emery against a substrate under high pressure to form numerous irregular raised/recessed structures on the surface of the substrate by the impact of emery under high pressure. This also forms a matte-surface substrate. However, such processing of jetting emery is a mechanical operation that causes minor destruction of the substrate surface and may undesirably damage the material structure of the substrate and affect the lifespan of the substrate.

A different process of mist spraying is also proposed, which sprays particles toward a surface of the substrate to have the particles attached to the substrate surface so as to realize surface matting. However, the particles attached to the substrate surface in this way may get easily detached, negatively affecting the effect of surface matting.

### SUMMARY OF THE INVENTION

In view of the above discussed, the present invention provides a matte-surface substrate and a manufacturing method thereof, in which a difference between surface tensions of two materials is utilized to form irregular raised/recessed structures for generating a surface matting effect. As such, the matte-surface substrate and the manufacturing method thereof proposed by the present invention do need chemical agents for etching and thus do not cause pollution to the environments, nor damage the inherent structure of the substrate, whereby the lifespan and reliability of the matte-surface substrate are both improved.

The present invention provides a method for manufacturing matte-surface substrate, comprising the following steps: coating a layer of material layer on a substrate; forming a plurality of liquid dewdrops on a surface of the coated material layer, the liquid dewdrops and the coated material layer being of different surface tensions; causing shape variation of the surface of the coated material layer to form a plurality of irregular raised/recessed structures; and curing the coated material layers and removing the liquid dewdrops.

The present invention also provides a matte-surface substrate, which comprises a substrate and a coated material layer. The coated material layer is coated on the substrate, and the coated material layer has a surface forming a plurality of irregular raised/recessed structures, wherein the irregular raised/recessed structures are formed through the following steps: forming a plurality of liquid dewdrops on the surface of the coated material layer to induce an action that is caused by a difference of surface tension between the liquid dewdrops and the coated material layer or caused by non-uniform concentration therebetween; causing shape variation of the surface of the coated material layer to form the irregular raised/recessed structures; and curing the coated material layer and removing the liquid dewdrops.

### BRIEF DESCRIPTION OF THE DRAWINGS

The present invention will be apparent to those skilled in the art by reading the following description of preferred embodiments of the present invention and the best mode for carrying out the invention, with reference to the attached drawings, in which:

FIG. 1 is a schematic view showing a first example of conventional matte-surface substrate;

FIG. 2 is another schematic view of the first example of conventional matte-surface substrate;

FIG. 3 is a further schematic view of the first example of conventional matte-surface substrate;

FIG. 4 is a schematic view showing a second example of conventional matte-surface substrate;

FIG. 5 is another schematic view of the second example of conventional matte-surface substrate;

FIG. 6 is a further schematic view of the second example of conventional matte-surface substrate;

FIG. 7 is a schematic view showing a substrate coated with a layer of material thereon according to a first embodiment of the present invention;

FIG. 8 is a schematic view showing a matte-surface substrate according to the present invention is placed in a humidity-containing space;

FIG. 9 is a schematic view showing the matte-surface substrate according to the first embodiment of the present invention;

FIG. 10 schematically shows an enlarged view of circled area C1 of FIG. 9;

FIG. 11 is another schematic view of the matte-surface substrate according to the first embodiment of the present invention;

FIG. 12 schematically shows an enlarged view of circled area C2 of FIG. 11;

FIG. 13 is a schematic view showing a matte-surface substrate according to a second embodiment of the present invention;

FIG. 14 schematically shows an enlarged view of circled area C3 of FIG. 13;

FIG. 15 is another schematic view of the matte-surface substrate according to the second embodiment of the present invention; and

FIG. 16 schematically shows an enlarged view of circled area C4 of FIG. 15.

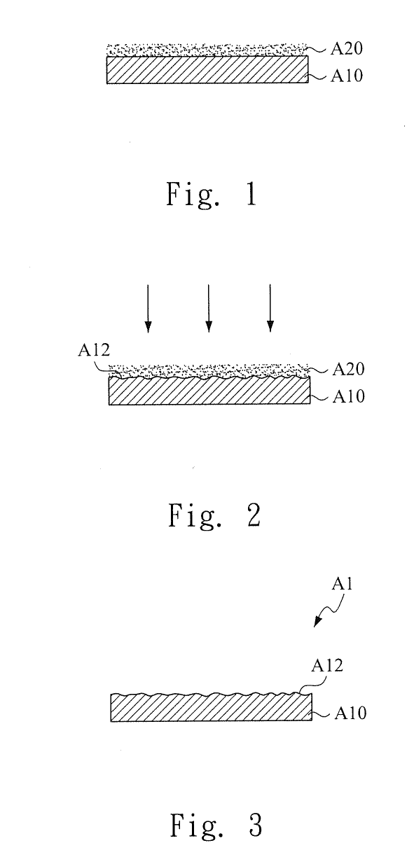

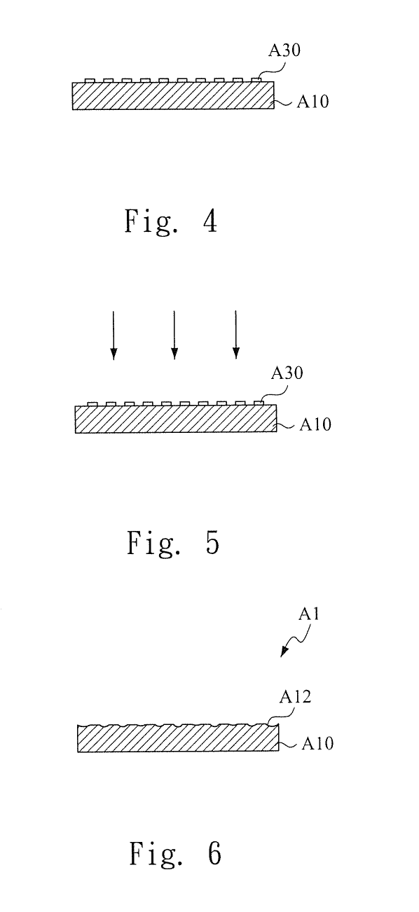

### DETAILED DESCRIPTION OF THE PREFERRED EMBODIMENTS AND BEST MODE FOR CARRYING OUT THE INVENTION

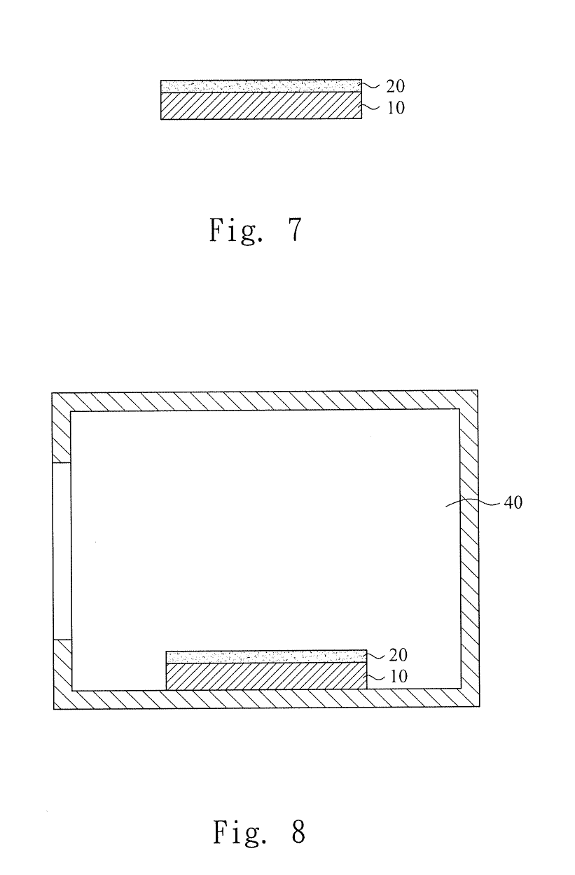

With reference to the drawings and in particular to FIG. 7, which is a schematic view showing a substrate is coated with a layer of material thereon according to a first embodiment of the present invention, a matte-surface substrate according to the present invention comprises: a substrate 10 and a layer 20 of coated material. The coated material layer 20 is formed on a surface of the substrate 10. The substrate 10 can be made of glass or plastics, but the present invention is not limited thereto. Then, a plurality of liquid dewdrops is formed on a surface of the coated material layer 20, and the liquid dewdrops and the coated material layer 20 are of different surface tensions.

Referring to FIG. 8, which illustrates an embodiment for forming the liquid dewdrops on the coated material layer 20, in which the liquid dewdrops are formed through a dewing process. The substrate 10 that is coated with the coated material layer 20 is placed in a humidity-containing space 40, and the humidity-containing space 40 is set at humidity and temperature that are suitable for dewing. When the substrate 10 that is coated with the coated material layer 20 is placed in the humidity-containing space 40, and the temperature is set lower than the dewing point of the space 40, or alternatively, the humidity inside the space 40 is made saturated, a number of dewdrops are formed on the coated material layer 20. The liquid dewdrops can be water or a solvent, but the present invention is not limited thereto. Further, the liquid dewdrops and the coated material layer 20 are insoluble or slightly soluble with respect to each other, but the present invention is not limited thereto.

It is noted there the formation of the liquid dewdrops on the surface of the coated material layer 20 is not limited to the dewing process discussed above, and alternatively, a spraying process may also be applicable to directly spray dewdrops onto the surface of the coated material layer 20.

When a large number of dewdrops are formed on the surface of the coated material layer 20, due to difference in properties of the two materials, different surface tensions are induced. Thus, based on the difference of surface tension between the liquid dewdrops and the coated material layer 20, the coated material layer 20 of which the surface is not yet cured may be caused to generate variation in the shape thereof. Then, the coated material layer 20 is made cured to fix the shape, whereby numerous irregular raised/recessed structures are presented on the surface of the coated material layer.

The interaction between the liquid dewdrops and the coated material layer 20 are generally of two types, which are the coated material layer 20 and the liquid dewdrops being slightly soluble with respect to each other and the surface tension of the coated material layer 20 being smaller than the surface tension of the liquid dewdrops and they will be individually described.

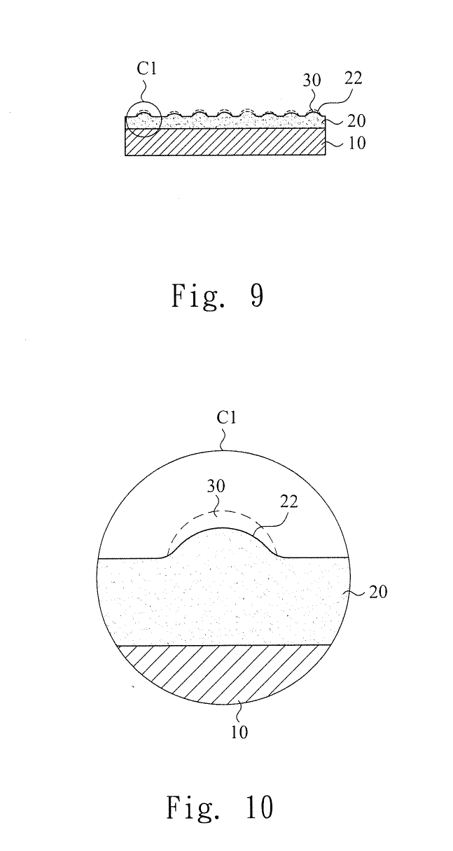

Referring to FIGS. 9-12, the first type that the coated material layer and the liquid dewdrops are slightly soluble to each other will be first described as a first example. As shown in FIG. 9, a number of liquid dewdrops 30 are formed on the surface of the coated material layer 20. Since the liquid dewdrops 30 are slightly soluble in the coated material layer 20, the surface of the coated material layer 20 forms irregular raised/recessed structures at areas corresponding to the liquid dewdrops 30, which are formed by the liquid dewdrops 30 slightly dissolved in the coated material layer 20. On the contrary, the areas of the surface of the coated material layer 20 that do not receive liquid dewdrops 30 formed thereon may maintain the original shape and unchanged. As such, numerous irregular raised/recessed structures 22 are formed as shown in FIG. 9. FIG. 10 schematically illustrates an enlarged view of a circled area C1 of FIG. 9.

Referring to FIG. 11, after the surface of the coated material layer 20 is partially dissolved in the liquid dewdrops to cause non-uniform concentration and thus changes of shape, which lead to the formation of a number of irregular raised/recessed structure 22, the coated material layer 20 may then be cured to solidify and fix the irregular raised/recessed structures 22 formed in the coated material layer 20 and the surface thereof. It is noted here that curing the coated material layer 20 can be realized through ultraviolet curing or heat curing or humidity curing, and the present invention is not limited thereto and other curing processes can be selectively applied according to the material property of the coated material layer 20. Further, in the step of curing, the liquid dewdrops 30 are also removed, or alternatively, the liquid dewdrops 30 can be removed after the curing step is completed, but the present invention is not limited thereto.

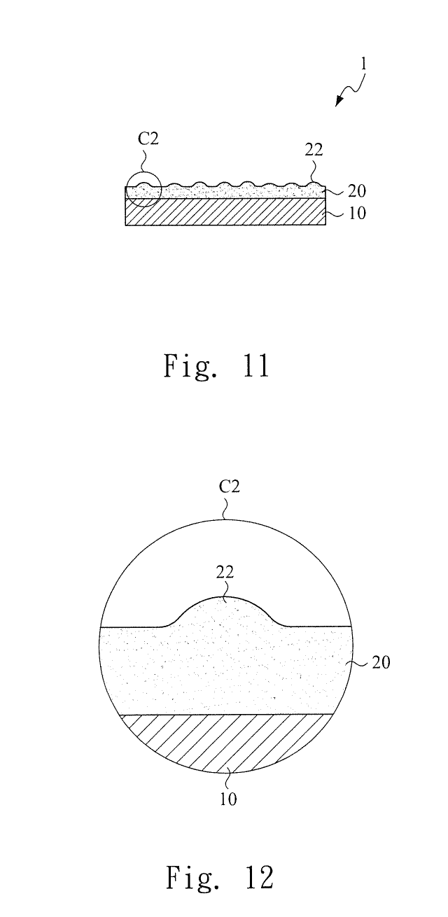

Referring to FIG. 11, after the coated material layer 20 is cured and the liquid dewdrops 30 are removed, the matte-surface substrate 1 according to the present invention is completed. The drawing clearly shows that the substrate 10 is coated with the coated material layer 20 thereon and the surface of the coated material layer 20 forms a plurality of irregular raised/recessed structures 22. With the irregular raised/recessed structures 22, a surface matting or frosting effect is achieved. FIG. 12 schematically illustrates an enlarged view of a circled area C2 of FIG. 11.

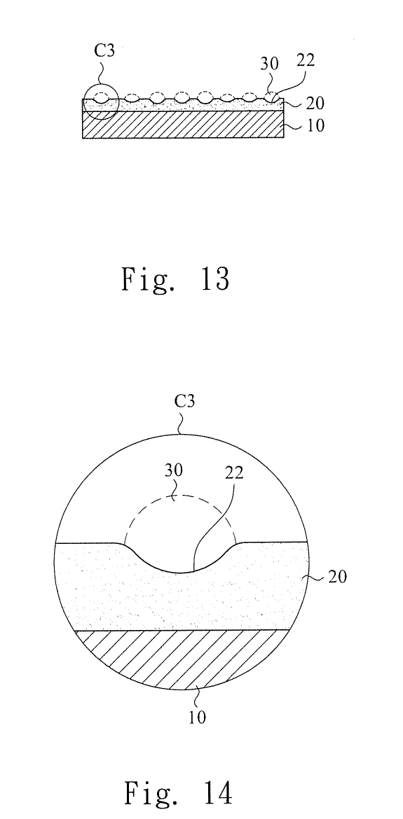

Referring to FIGS. 13-16, the second type that the surface tension of the coated material layer is smaller than the surface tension of the liquid dewdrops will be described as a second example. As shown in FIG. 13, a number of liquid dewdrops 30 are formed on a surface of the coated material layer 20. Since the surface tension of the coated material layer 20 is smaller than the surface tension of the liquid dewdrops 30, the surface of the coated material layer 20 forms a plurality of areas that correspond to the liquid dewdrops 30 and are recessed due to the action of the surface tension. On the other hand, the areas of the surface of the coated material layer 20 on which no liquid dewdrops 30 are formed may maintain the original shape and unchanged. As such, numerous irregular raised/recessed structures 22 are formed as shown in FIG. 13. FIG. 14 schematically illustrates an enlarged view of a circled area C3 of FIG. 13.

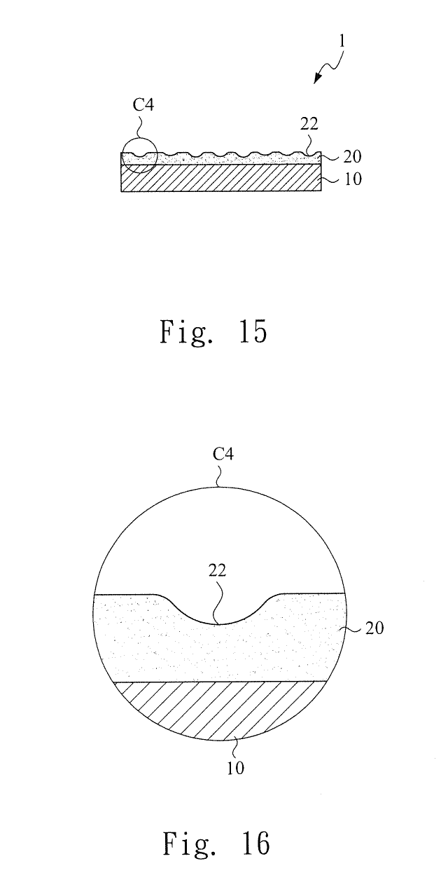

Referring to FIG. 15, after the surface of the coated material layer 20 is caused by the surface tension to generate a number of irregular raised/recessed structures 22, the coated material layer 20 may then be cured to solidify and fix the irregular raised/recessed structures 22 formed in the coated material layer 20 and the surface thereof. It is noted here that curing the coated material layer 20 can be realized through ultraviolet curing or heat curing or humidity curing, and the present invention is not limited thereto and other curing processes can be selectively applied according to the material property of the coated material layer 20. Further, in the step of curing, the liquid dewdrops 30 are also removed, or alternatively, the liquid dewdrops 30 can be removed after the curing step is completed.

Referring to FIG. 15, after the coated material layer 20 is cured and the liquid dewdrops 30 are removed, the matte-surface substrate 1 is completed. The drawing clearly shows that the substrate 10 is coated with the coated material layer 20 thereon and the surface of the coated material layer 20 forms a plurality of irregular raised/recessed structures 22. With the irregular raised/recessed structures 22, a surface matting or frosting effect is achieved. FIG. 16 schematically illustrates an enlarged view of a circled area C4 of FIG. 15.

The above description shows that the matte-surface substrate and the manufacturing method thereof proposed by the present invention applies a layer of coated material on a substrate and then forms a plurality of liquid dewdrops on the coated material layer. With an action caused by a difference of surface tension existing between the coated material layer and the liquid dewdrops or an action caused by difference of concentration between the coated material layer and the liquid dewdrops, an uncured surface of the coated material layer is caused to generate variation of shape, thereby forming irregular raised/recessed structures. Finally, the coated material layer is cured ad the liquid dewdrops removed to complete the formation of the matte-surface substrate.

To this point, it is appreciated that the matte-surface substrate and the manufacturing method thereof proposed by the present invention do not need any chemical agent that is required in the conventional methods and thus do not cause pollution to the environments. Further, the irregular raised/recessed structures are formed by using the coated material layer, so that no damage may be caused on the inherent structure of the substrate. Thus, the present invention is of great help in improving the lifespan and the reliability of the matte-surface substrate.

Although the present invention has been described with reference to the preferred embodiments thereof, as well as the best modes for carrying out the invention, it is apparent to those skilled in the art that a variety of modifications and changes may be made without departing from the scope of the present invention which is intended to be defined by the appended claims.

What is claimed is:

1. A method for manufacturing matte-surface substrate, comprising the following steps:
coating a coated material layer on a substrate;
forming a plurality of liquid dewdrops on a surface of the coated material layer, the liquid dewdrops and the coated material layer being of different surface tensions;
applying the difference of surface tensions between the liquid dewdrops and the coated material layer to cause shape variation of the surface of the coated material layer so as to form a plurality of irregular raised/recessed structures; and
curing the coated material layer and removing the liquid dewdrops.

2. The method as claimed in claim 1, wherein the step of forming the plurality of liquid dewdrops on the surface of the coated material layer comprises:
placing the substrate that is coated with the coated material layer in a humidity-containing space; and
carrying out a dewing process to form the liquid dewdrops on the surface of the coated material layer.

3. The method as claimed in claim 1, wherein the step of forming the plurality of liquid dewdrops on the surface of the coated material layer comprises:
carrying out a spraying process to spray the liquid dewdrops onto the surface of the coated material layer.

4. The method as claimed in claim 1, wherein the liquid dewdrops comprise water or solvent.

5. The method as claimed in claim 1, wherein the step of curing the coated material layer comprises ultraviolet curing, heat curing, or humidity curing.

6. The method as claimed in claim 1, wherein the substrate comprises glass or plastic.

7. A matte-surface substrate, comprising:
a substrate; and
a coated material layer, which is coated on a surface of the substrate, the coated material layer having a surface forming a plurality of successively-arranged irregular raised/recessed structures, which are formed through the following steps:
forming a plurality of liquid dewdrops on the surface of the coated material layer;
applying an action between the liquid dewdrops and the coated material layer to cause shape variation of the surface of the coated material layer so as to form the irregular raised/recessed structures; and
curing the coated material layer and removing the liquid dewdrops.

8. The matte-surface substrate forming the successively-arranged irregular raised/recessed structures as claimed in claim 7, wherein the action between the liquid dewdrops and the coated material layer comprises a difference of surface tensions of the liquid dewdrops and the coated material layer or non-uniform concentration between the liquid dewdrops and the coated material layer.

9. The matte-surface substrate as claimed in claim 7, wherein the substrate comprises glass or plastic.

10. The matte-surface substrate as claimed in claim 7, wherein curing the coated material layer comprises ultraviolet curing, heat curing, or humidity curing.

11. The matte-surface substrate as claimed in claim 7, wherein the liquid dewdrops comprise water or solvent and are formed on the surface of the coated material layer through dewing or spraying.
